(19) United States
(12) Patent Application Publication
(10) Pub. No.: US 2016/0358289 A1
(43) Pub. Date: Dec. 8, 2016

(54) Mail Order Prescription System and Method

(71) Applicant: Humana Inc., (US)

(72) Inventors: Nick Walter, Louisville, KY (US); Kia N. Gaines, Scottsdale, AZ (US); Zoran Dzindic, Louisville, KY (US); Ryan Prescott Reed, Louisville, KY (US)

(73) Assignee: HUMANA INC., Louisville, KY (US)

(21) Appl. No.: 13/712,610

(22) Filed: Dec. 12, 2012

(51) Int. Cl. G06Q 50/22

(52) U.S. Cl. CPC G06Q 50/22

(57) ABSTRACT

A mail order prescription system and method for a mail order pharmacy program is disclosed. The mail order prescription system and method supports enrollment and management of health benefit plan members in a mail order pharmacy program. The system and method support switching previously filled prescriptions to a mail order pharmacy program. The system and method also allow users to enter data for new, previously unfilled prescriptions. The system and method further facilitate contacting prescribing physicians and obtaining authorization for fulfillment of prescriptions by mail. In an example embodiment, users access a web portal to view prescription data for a member and to switch current prescriptions to mail order and/or to enter data for new prescriptions. Additional cost savings may be realized by allowing users to select a generic equivalent or a generic alternative instead of an original prescription.

### CROSS-REFERENCE TO RELATED APPLICATIONS

None.

### BACKGROUND

Many health benefit plan providers offer their plan members the option of obtaining their prescription drugs by mail. For members with chronic conditions or other conditions that require maintenance drugs, a mail order prescription program is an attractive benefit because it is more convenient for members and typically less expensive than obtaining prescription drugs at a neighborhood pharmacy. For many drugs, members have the option of purchasing a drug fill in a 60-day or even a 90-day supply at a lower cost than a 30-day supply.

Although plan members as well as health benefit plan providers benefit from the convenience and lower cost of mail order prescription programs, members are often unaware of the mail order option. Even if they are aware of the option, they may be uncertain about what they need to do to take advantage of the program or which prescriptions they can obtain by mail. Some health benefit plan providers review member pharmacy claim data to identify members with prescription needs that may be fulfilled through a mail order pharmacy. Although review of pharmacy claim data is an effective way to identify candidates for a mail order pharmacy program, members are not notified of the option until after an initial fill for the prescription has been processed and a claim for the fill has been submitted to health plan provider. To take advantage of the mail order option, the member must “switch” the prescription from a current fulfillment option to a mail order option. “Switching” the prescription may require contacting the prescribing physician for authorization to refill the prescription from another source. If the physician provides authorization for refills directly to the member's dispensing pharmacy, “switching” may require providing the physician with new contact information to authorize dispensing of additional fills from the mail order pharmacy.

Some health benefit plan providers offer members a web-based “self-serve” option for enrolling in a mail order pharmacy program and “switching” prescriptions. Members may access a web portal that supports enrollment in a mail order pharmacy program. Typically, the member's pharmacy claim data is automatically reviewed to identify one or more prescriptions that may be fulfilled by mail. The member's prescriptions are identified in a list and the member is provided with a mail order option if the prescription can be filled by mail. The member may be prompted for additional data needed to complete the switch to the mail order option such as a mailing address and payment information as well as prescribing physician contact data.

The health benefits plan provider may also offer enrollment services through a live assistance customer service center. Contact may be initiated by the member or by associates at the center that have access to member data including the member's telephone number. For members with mail order eligible prescriptions, associates at the center may call the member to discuss the mail order option and facilitate the member's switch to mail order using a web-based system that is similar to the “self-serve” system. An associate requests data from the member, enters it in the web-based system, and completes arrangements for the switch such as contacting the prescribing physician to authorize additional fills from the new source.

Although health benefit plan members as well as health benefit plan providers benefit from members “switching” to a mail order pharmacy program, additional benefits may be realized by providing members with a mail order option for filling an initial fill of a prescription. If an initial fill of a prescription and subsequent fills of the prescription are processed through a mail order pharmacy program, the member can take advantage of the convenience and cost savings from the beginning and avoid “switching” the prescription. There is a need for a mail order prescription system and method that allows a member to enter data for a new, previously unfilled prescription. There is a need for a prescription ordering system and method that supports delivery of prescriptions by mail by completing necessary arrangements such as contacting prescribing physicians and obtaining authorization. There is a need for prescription ordering system and method that allows a member to take advantage of the convenience and cost savings of a mail order pharmacy program for new prescriptions.

### SUMMARY

The present disclosure is directed to a mail order prescription system and method. The mail order prescription system and method supports enrollment and management of health benefit plan members in a mail order pharmacy program. The mail order prescription system and method supports previously filled prescriptions and allows members to enter data for a new, previously unfilled prescriptions. The prescription ordering system and method supports delivery of prescriptions by mail by completing necessary arrangements such as contacting prescribing physicians and obtaining authorization. The disclosed prescription ordering system and method allows a member to take advantage of the convenience and cost savings of a mail order pharmacy program for new prescriptions as well as prescriptions previously filled through other sources.

In an example embodiment, a mail order prescription program is supported by a web portal that allows a user to “switch” current prescriptions and to enter data for new prescriptions. In a self-serve version of the portal, members can review current prescription data and switch eligible prescriptions to a mail order pharmacy program. Members can also add new prescriptions to be fulfilled through the mail order pharmacy program. The member is prompted for data needed for physician authorization to fill the prescription by mail. Another version of the portal may be accessible to associates of the health benefits plan provider that assist members with managing one or more prescriptions that may be filled by mail. If the member has a new prescription, the associate can add the member's new prescription to be fulfilled through the mail order pharmacy. The associated is prompted for data needed for physician authorization to fill the prescription by mail.

In an example embodiment, a Therapeutic Interchange Program (TIP) feature provides additional benefits to members by increasing the number of lower cost alternatives available to members and allowing members to switch to these lower cost alternatives. Members may realize additional cost savings by selecting a generic equivalent or a generic alternative instead of an original prescription. If one or more generic equivalents or alternatives are available for a prescription in the member's list, the member is notified of the other options. The mail order prescription system and method supports the selection of a generic equivalent or a generic alternative by facilitating physician authorization for the selected option.

### BRIEF DESCRIPTION OF THE DRAWINGS

FIG. 1 is a mail order prescription program landing page for a mail order prescription program portal according to an example embodiment;

FIG. 2A is a prescription list page according to an example embodiment;

FIG. 2B is a prescription list page comprising generic alternatives according to an example embodiment;

FIG. 3 is a prescription and supply information page according to an example embodiment;

FIG. 4 is a shipping and payment information page according to an example embodiment; and

FIGS. 5A-5F are pages for an “add a prescription” process according to an example embodiment.

### DETAILED DESCRIPTION

In an example embodiment of a mail order prescription program available from a health benefits plan provider, members or associates of the provider access a web portal to manage one or more member prescriptions that are filled by mail. The health benefits plan provider may maintain one or more databases comprising drug data for drugs available through the mail order pharmacy program. The health benefits plan provider may further maintain one or more databases comprising member pharmacy claim data for drugs that have been prescribed for the member. Each member's pharmacy claim data may be reviewed to identify prescriptions that could be filled through the mail order pharmacy program. Eligible prescriptions are identified with a target drug list for the mail order pharmacy that is used to filter against pharmacy claims data for prescriptions filled at retail pharmacies. Drugs from the target list that are found in the claims data are flagged as prescriptions that may be moved.

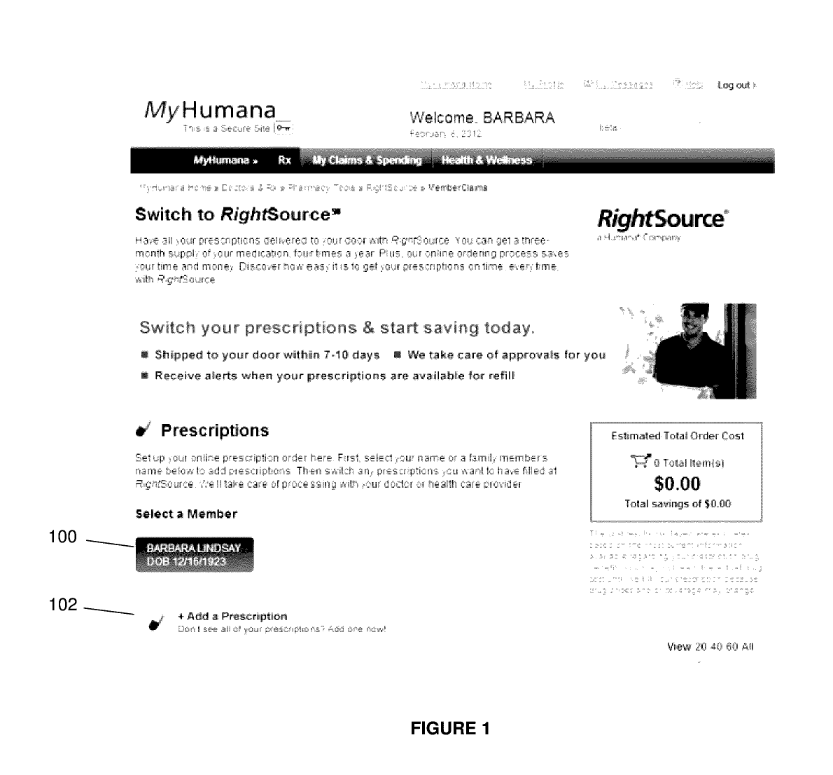

Referring to FIG. 1, a mail order prescription program landing page for a mail order prescription program portal according to an example embodiment is shown. The landing page provides background information about the program. In addition, the page identifies a member of the health benefits plan that may be able to take advantage of the mail order program 100. If more than one member is covered under the plan, identifying data for additional members may be displayed. The landing page further comprises an “add a prescription option” 102.

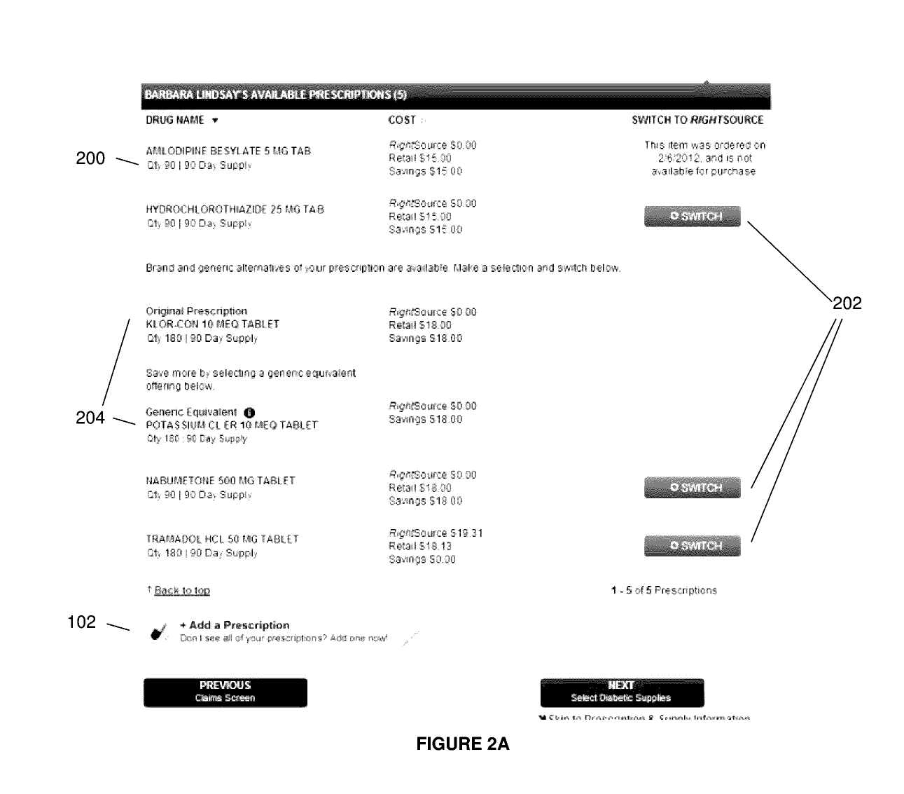

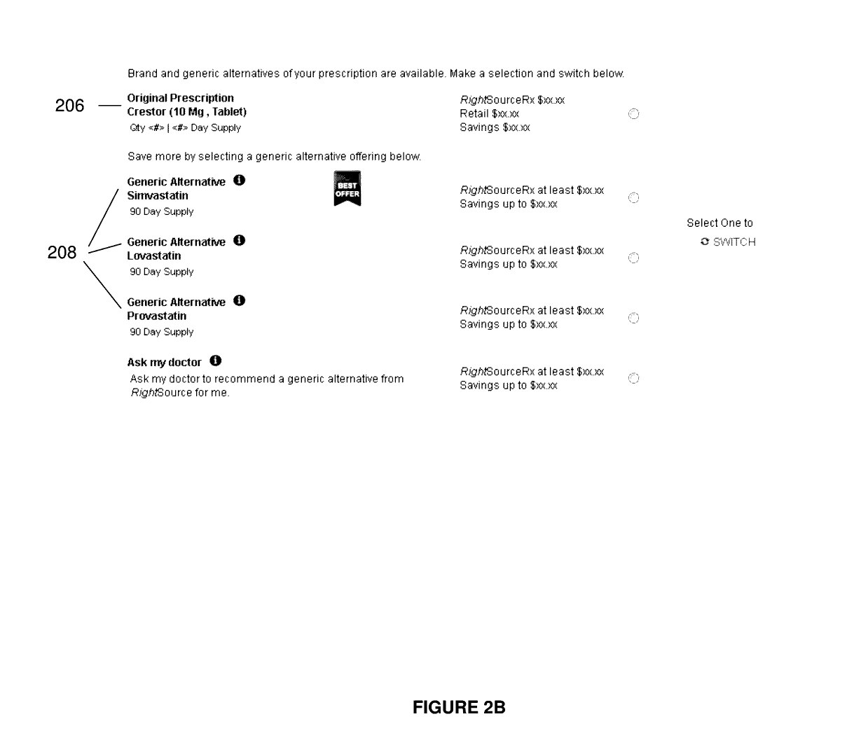

Referring to FIG. 2A, a prescription list page according to an example embodiment is shown. The page comprises a list of prescriptions for the selected member 200. An initial prescription list may be generated based on an automated review of the member's pharmacy claim data. If any of the prescriptions can be purchased through the mail order pharmacy program, a “switch” option is displayed in proximity to the prescription 202. A Therapeutic Interchange Program (TIP) feature identifies lower cost alternatives that are available for a listed drug. If a generic equivalent is available for any of the prescriptions, details for the equivalent are displayed in proximity to the original prescription 204. The member may select the equivalent to realize additional cost savings. A newly prescribed drug may be added to the list by selecting the “add a prescription” option 102.

Referring to FIG. 2B, a prescription list page comprising generic alternatives is shown. In an example embodiment, the prescription list may further identify generic alternatives 208 for an original prescription 208. The ability to review and select a generic equivalent (or a generic alternative as shown in FIG. 2A) for a prescribed drug provides additional cost savings opportunities for members of the health benefits plan.

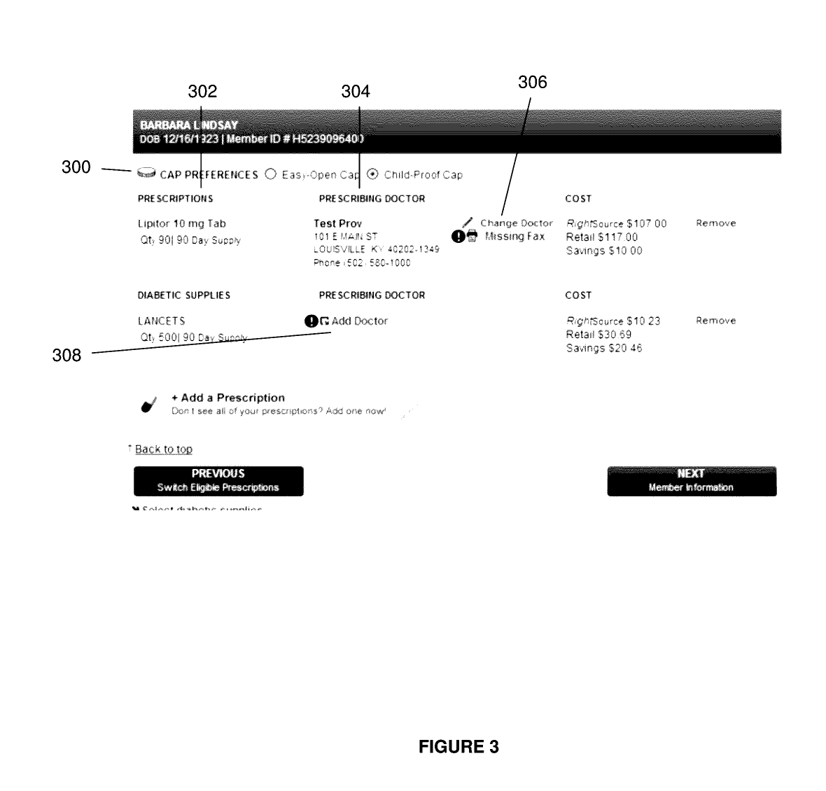

Referring to FIG. 3, a prescription and supply information page according to an example embodiment is shown. This page is displayed when the user selects the “switch” option to start receiving one or more prescriptions by mail. Initially, the user is prompted to specify a “cap preference” 300. The page comprises identifying data for each prescription 302 and contact data for the prescribing physician 304. The user may further be prompted to provide additional data to facilitate fulfillment of the prescription by mail. If a fax number for the prescribing physician has not been provided, the user is prompted to provide the missing data 306. Additionally, the user may change the prescribing physician data if the drug was prescribed by a new doctor. If the prescribing physician data is missing, the user is prompted to provide it 308.

In an example embodiment, the fax data for the prescribing physician is used to facilitate obtaining authorization for dispensing the prescription from the mail order pharmacy. The fax and prescription data may be used in an automated process for generating and sending authorization fax messages to the prescribing physicians. Once the prescribing physician's authorization is received, fills for the prescribed drug may be processed through the mail order pharmacy.

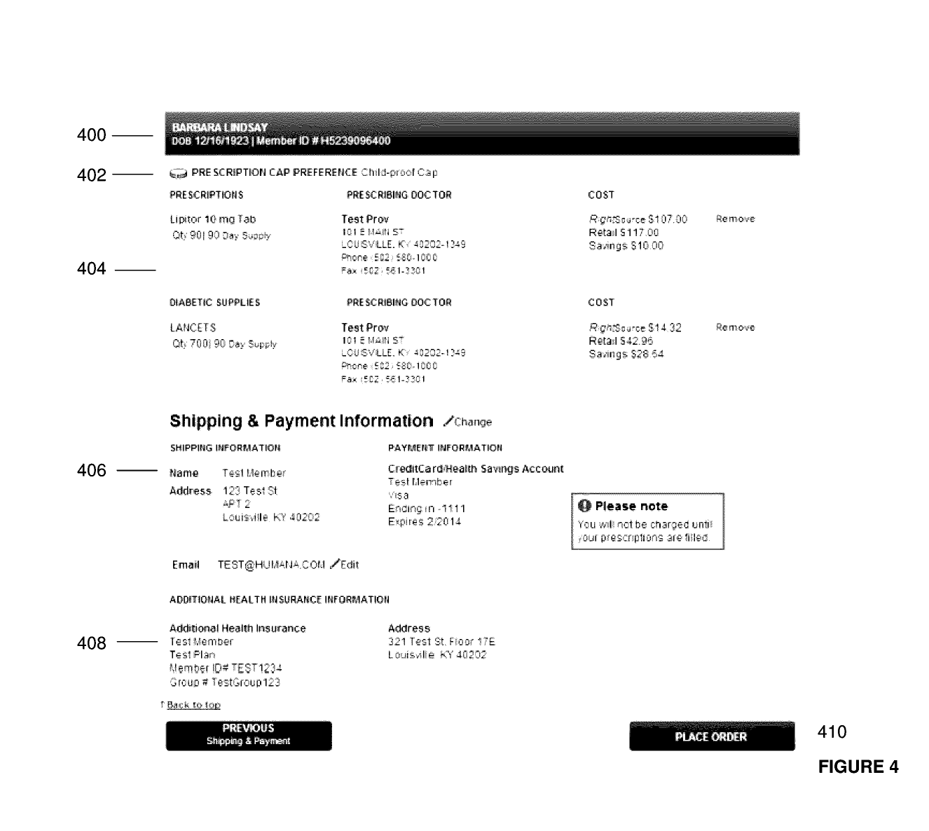

Referring to FIG. 4, a shipping and payment information page according to an example embodiment is shown. The page comprises identifying information for the member 400, the member's cap preference 402, identifying data for the member's prescriptions to be fulfilled by mail order 404, shipping and payment information 406, and health plan data 408. If the information appearing on the page is correct, the user may select the “place order” option 410. The order is then transmitted to an order fulfillment system for a mail order pharmacy.

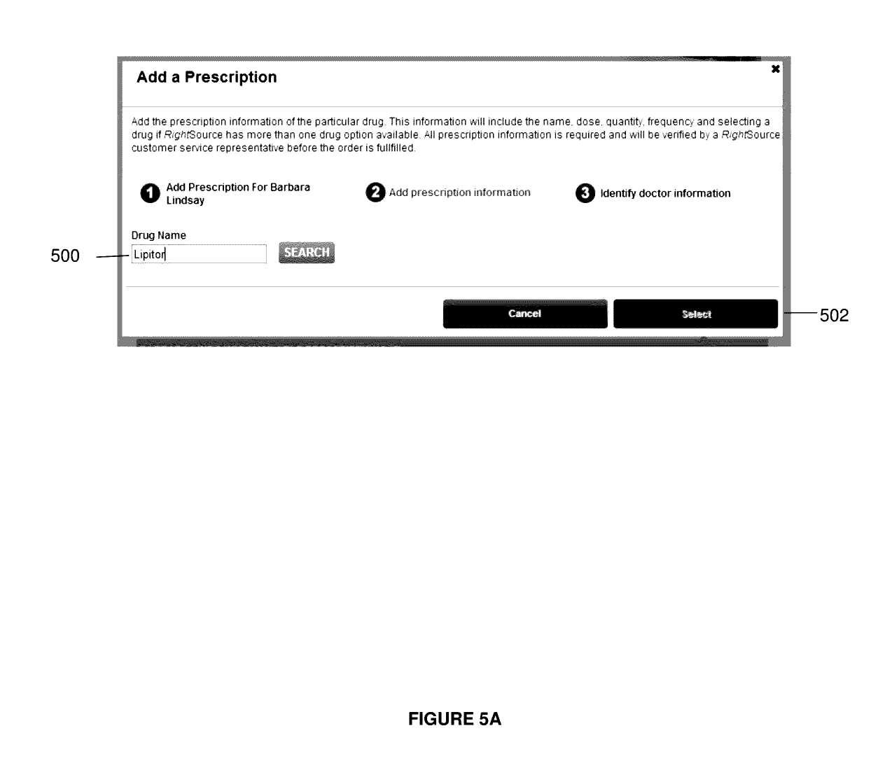

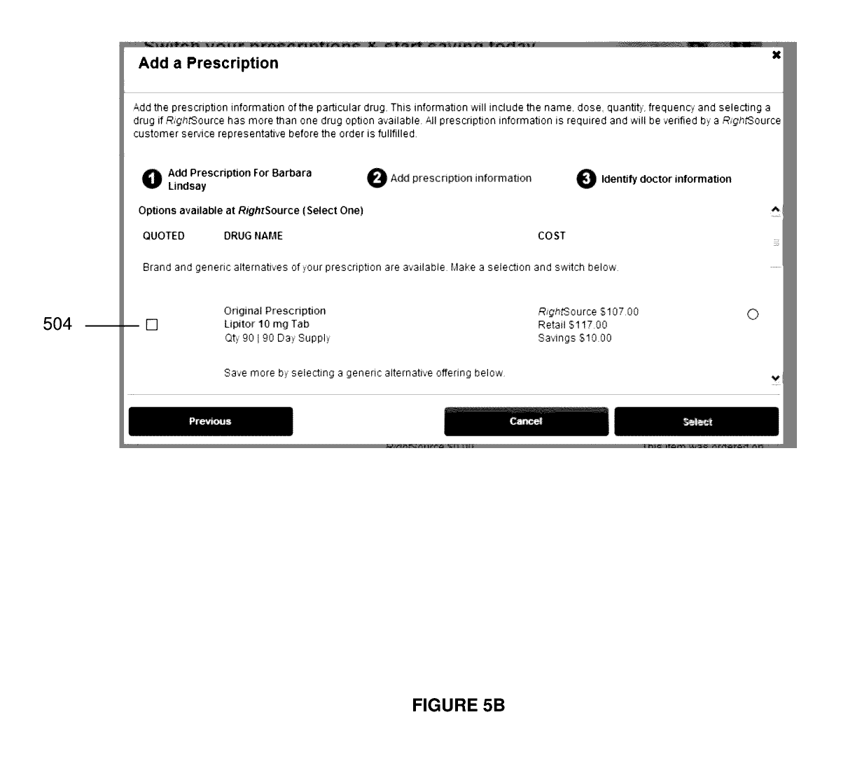

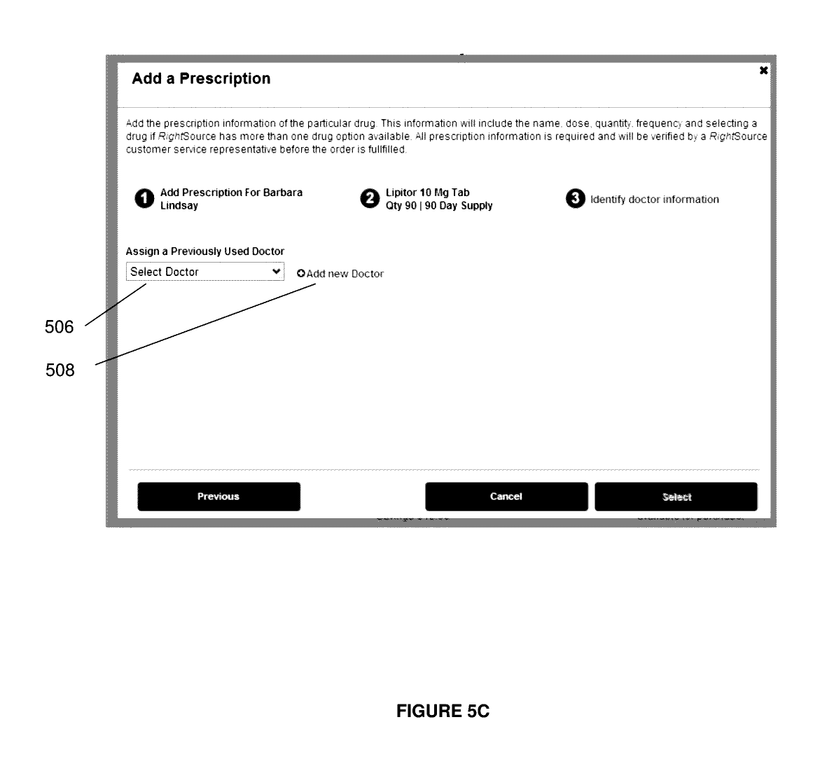

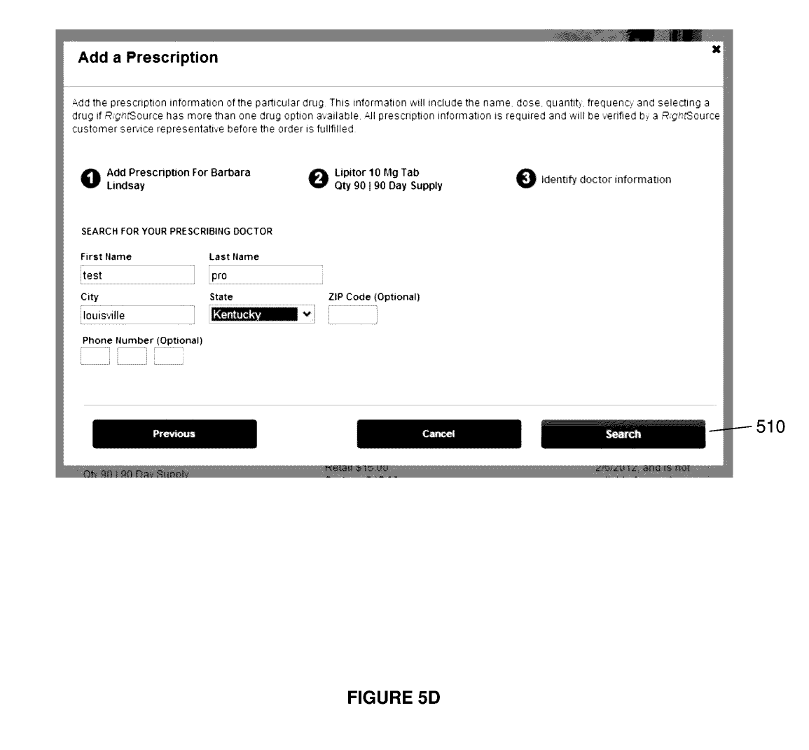

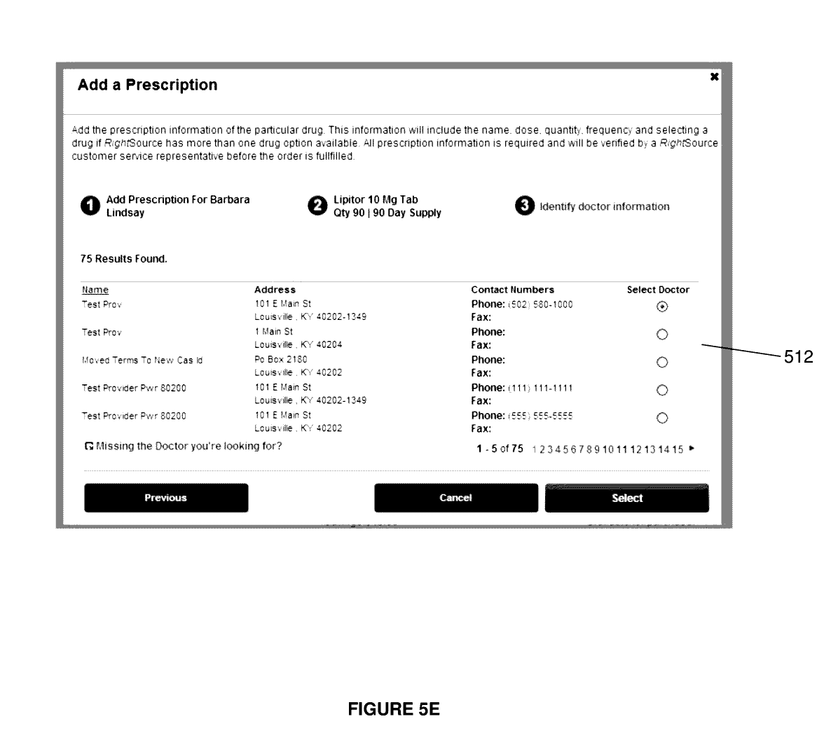

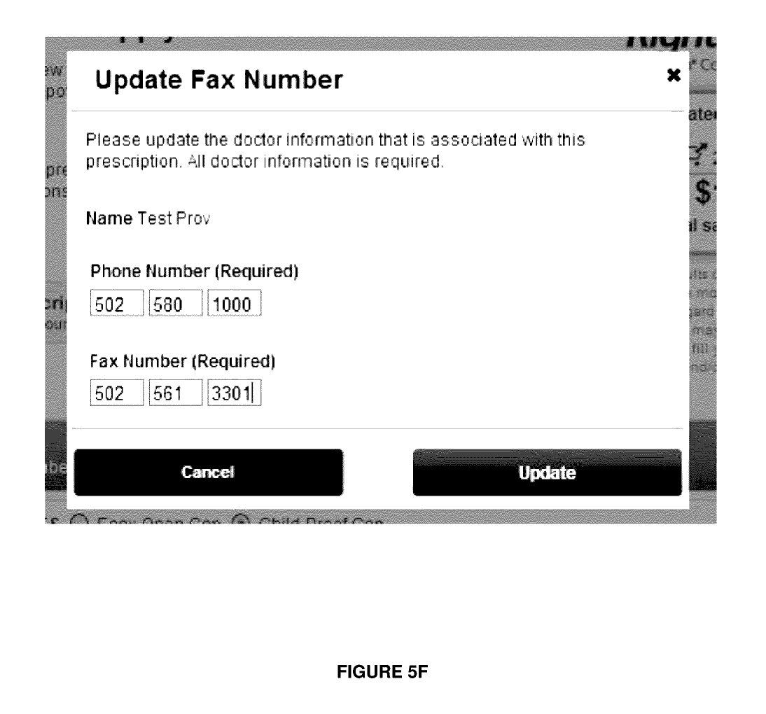

Referring to FIGS. 5A-5F, pages for an “add a prescription” process according to an example embodiment is shown. Referring to FIG. 5A, initially, the user is prompted for the drug name 500. The “select” option 502 results in a search for the specified drug. Referring to FIG. 5B, a search results page is shown. A search results page may comprise one or more options that meet the search criteria. The user is prompted to select a drug from the list 504.

Referring to FIG. 5C, the user is next prompted for prescribing physician information. The user may select from a list of doctors for whom contact information has been provided previously 506 or the user may provide contact information for a new doctor 508.

Referring to FIG. 5D, the user may search for a prescribing physician by entering search criteria in the fields. The search begins when the user selects the search option 510. Referring to FIG. 5E, a “prescribing physician” search results page is shown. Data for doctors that match the selection criteria is displayed. The user may select from among the listed doctors to identify the prescribing physician 512. If the contact data for the selected doctor is incomplete, the user is redirected to a page for entering current contact data. Referring to FIG. 5F, an update telephone and fax numbers page is shown. The user is prompted to provide current telephone and fax numbers for the prescribing physician to facilitate approval for the mail order prescription.

In an example embodiment, a “retail-to-mail” application sends the information that is included in the order (i.e., prescriptions, provider contact data, member information, etc.) to a pharmacy management system that sends the prescription and provider data to an automated faxing system. Faxes to prescribing physicians are transmitted using an automated outbound fax system such as one offered by FairFax Imaging, Inc. In an example embodiment, fax forms for mail order pharmacy requests are auto-populated using an XML process. In an example embodiment, the following are fields are populated:

TABLE 1
Fax Form Fields

```
Agent Identifier
Reference Number
Mail Order Pharmacy Request Number
Mail Order Pharmacy Account Number
Patient Information
  Name
  Member Date of Birth
  Member Identifier
Physician Information
  Name
  Address
  City/State/Zip
  Telephone Number
  Fax Number
Member Shipping Information
  Name
  Address
  City/State/Zip
  Telephone Number
Drug Name
Brand Name Generic Drug
Quantity (Diabetes Supplies)
```

After the fax form is populated with required data and a unique Mail Order Pharmacy Request Number, a cover letter may be added to the form that indicates the attempt number of the request (e.g., first request, second request, third request, final request). The cover letter and form are then transmitted to the prescribing physician. The document may be transmitted using an automated outbound fax system and the fax number from the request. The system follows a fax outreach timeline established by the physician.

Automated fax requests may be logged and tracked according to the Mail Order Pharmacy Request Number as indicated in the XML file. When a fax is received at the prescribing physician's facility, the request may be closed out in a backend system so that no further communications are sent to the member or to the physician. In addition, the unique request number identifies where the request originated. The XML file may identify a department of the health benefits plan provider. The request originator may be one of the following:

TABLE 2
Fax Originators

Member
Mail Order Pharmacy Enrollment Agent
Mail Order Pharmacy Customer Service Agent
Personal Nurse
Commercial Case Management
Senior Case Management

The tracking system may have functionality such as the following. If the prescribing physician responds by fax, a fax back image may be attached to the original fax. In addition, exceptions to the original outbound request may be attached. If a fax back is matched to an original fax back template, a validation process may be executed. In addition, the tracking system may interpret the status of a fax (e.g., a received fax, an undeliverable fax, and a bad fax number). If the fax is received by the prescribing physician, the outbound fax system updates a corresponding backend system.

In the event the outbound fax system is unable to deliver the fax to the provided fax number, the system follows a busy/bad number procedure. If an outbound fax fails, the outbound fax system may update the status and resubmit the request. If the outbound fax system receives a busy signal, it continues to try and successfully send the fax to the physician. For example, it may make three attempts based on a configurable interval. If the outbound fax system is able to deliver the fax after the busy signal, it reports the result to the backend system with the fax receipt/status. If the outbound fax system cannot successfully deliver the fax during the allotted attempts, it follows undeliverable fax procedure.

If the delivery of a fax to a provider is undeliverable, the outbound fax system updates the backend system with an undeliverable status receipt and places the request in an appropriate failed fax queue for an associate to research and confirm the fax number. After the associate confirms the correct fax number, the associate updates the fax number, places the fax back into the backend system, and the system follows the original auto fax send process.

If the system determines that the number provided is a bad fax number (e.g., a normal phone number), the system updates the backend system and places the request in an appropriate failed fax queue for an associate to research and confirm the fax number. After the associate confirms the correct fax number, the associate updates the fax number, places the fax back into the backend system, and the system follows the original auto fax send process.

When a mail order pharmacy fax is received by the prescribing physician, the fax includes a barcode that includes all information from the XML file. The system can read the inquiry number/barcode and determine that the fax is a mail order pharmacy request and the department where the request originated. After the system has determined that the request is a mail order pharmacy fax, the system appropriately closes out the request and forwards information onto an item entry within other systems.

Once the request is sent from the automated faxing system to the pharmacy management system, it is reviewed for accuracy and approval. Once the review is complete, an order is created and then moved for review by a pharmacist before filling. Following pharmacist review, the order is filled and packaged for shipping.

While certain embodiments of the disclosed mail order prescription system and method are described in detail above, the scope of the invention is not to be considered limited by such disclosure, and modifications are possible without departing from the spirit of the invention as evidenced by the claims. For example, elements of the user interface and page layouts may be varied and fall within the scope of the claimed invention. Various aspects of user interactions and presentation of data may be varied and fall within the scope of the claimed invention. One skilled in the art would recognize that such modifications are possible without departing from the scope of the claimed invention.

1. A computerized method for ordering a prescribed drug comprising:
(a) receiving at a server from a user computer member identifying information for a member of a health benefits plan;
(b) generating at said server from pharmacy claim data for said member a prescribed drug list comprising at least one prescribed drug for said member;
(c) generating at said server for display at said user computer a first screen comprising:
(1) said prescribed drug list for said member; and
(2) a prompt to add a new prescribed drug to said prescribed drug list;
(d) receiving at said server from said user computer a request to add a new prescribed drug to said prescribed drug list, said request comprising:
(1) identifying data for said new prescribed drug; and
(2) contact data for a prescribing physician of said new prescribed drug comprising a fax number;
(e) comparing by said server said new prescribed drug to a target list of drugs to determine if said new prescribed drug is eligible for fulfillment from a mail order pharmacy program;
(f) prompting said member to receive said new prescribed drug from said mail order pharmacy program;
(g) in response to receiving from said user computer a selection of said prompt to receive said new prescribed drug from said mail order pharmacy program, generating at and transmitting from said server to an automated faxing system an electronic authorization request comprising:
(1) an authorization request number from said mail order pharmacy program; and
(2) said contact data for said prescribing physician;
(h) adding said electronic authorization request to a tracking system for said automated faxing system;
(i) receiving at said server from said automated faxing system in response to said electronic authorization request authorization from said prescribing physician;
(j) updating said electronic authorization request in said tracking system to indicate receipt of authorization from said prescribing physician;
(k) generating at said server an order for said new prescribed drug for fulfillment from said mail order pharmacy program; and
(l) transmitting said order from said server to a fulfillment system for said mail order pharmacy program.

2. The computerized method of claim 1 further comprising generating a second screen for display at said user computer comprising a prompt to select a mail order pharmacy program fulfillment option for a generic equivalent of said new prescribed drug.

3. The computerized method of claim 1 further comprising generating a second screen for display at said user computer comprising a prompt to select a mail order pharmacy program fulfillment option for a generic alternative of said new prescribed drug.

4. The computerized method of claim 1 wherein said prescribed drug list comprises a plurality of prescribed drugs.

5. The computerized method of claim 4 wherein said prescribed drug list comprises prompts for entering prescribing physician data.

6. (canceled)

7. A computerized method for ordering a prescribed drug comprising:
(a) receiving at a server from a user computer member identifying information for a member of a health benefits plan;
(b) comparing at said server at least one pharmacy claim for said member with a plurality of prescribed drugs on a target list of a mail order pharmacy program to identify a first prescribed drug from said pharmacy claim available by mail from said mail order pharmacy program;
(c) generating at said server for display at said user computer a screen comprising:
(1) identifying data for said first prescribed drug and a mail order pharmacy program option for said first prescribed drug for fulfillment from said mail order pharmacy program; and
(2) a prompt to add a prescription;
(d) receiving at said server from said user computer:
(1) a selection of said mail order pharmacy program option for said first prescribed drug; and
(2) a selection of said prompt to add a prescription;
(e) receiving at said server from said user computer:
(1) drug identifying data for a second prescribed drug;
(2) selection of a prompt to receive said second prescribed drug from said mail order pharmacy program following determination by said server said second prescribed drug is eligible for fulfillment from said mail order pharmacy program; and
(3) contact data for a prescribing physician of said second prescribed drug comprising a fax number;
(f) generating at and transmitting from said server to an automated faxing system an electronic authorization request comprising:
(1) an authorization request number from said mail order pharmacy program;
(2) said contact data for said prescribing physician and drug identifying data for said second prescribed drug;
(g) receiving at said server from said automated faxing system in response to said electronic authorization request authorization from said prescribing physician for said second prescribed drug;
(h) generating at said server an order for fulfillment from said mail order pharmacy program comprising said first prescribed drug and said second prescribed drug; and
(i) transmitting said order from said server to a fulfillment system for said mail order pharmacy program.

8. The computerized method of claim 7 wherein said mail order pharmacy program option associated with said first prescribed drug comprises a mail order pharmacy program option for a generic equivalent of said first prescribed drug.

9. The computerized method of claim 7 wherein said mail order pharmacy program option associated with said first prescribed drug comprises a mail order pharmacy program option for a generic alternative of said first prescribed drug.

10. The computerized method of claim 7 wherein said screen comprising said identifying data for said first prescribed drug further comprises a prompt for additional data related to said first prescribed drug.

11. (canceled)

12. The computerized method of claim 10 wherein said prompt for additional data comprises a prompt to add prescribing physician data.

13. The computerized method of claim 12 wherein said prompt to add prescribing physician data comprises a prompt to select a physician from a list of physicians.

14. The computerized method of claim 12 wherein said prompt to add prescribing physician data comprises a prompt to provide search criteria for a search of physician data.

15. A computerized method for ordering a prescribed drug comprising:
(a) receiving at a server from a user computer member identifying information for a member of a health benefits plan;
(b) receiving at said server from said user computer a request to add a prescription to a prescription list for said member;
(c) generating at said server for display at said user computer a first screen comprising a prompt for drug identifying data;
(d) receiving at said server from said user computer drug identifying data;
(e) confirming by said server said drug identifying data is on a target list of drugs for a mail order pharmacy program and eligible for fulfillment by mail;
(f) generating at said server for display at said user computer a second screen comprising at least one mail order pharmacy program option associated with said drug identifying data for fulfillment from said mail order pharmacy program;
(g) receiving at said server from said user computer a user selection of said at least one mail order pharmacy program option;
(h) generating at said server for display at said user computer a third screen comprising a prompt for contact data for a prescribing physician;
(i) receiving at said server from said user computer contact data for a prescribing physician wherein said contact data comprises a fax number;
(j) generating at and transmitting from said server to an automated faxing system an electronic authorization request comprising:
(1) an authorization request number from said mail order pharmacy program; and
(2) said contact data for said prescribing physician;
(k) receiving at said server from said automated faxing system in response to said electronic authorization request authorization from said prescribing physician;
(l) generating at said server an order comprising said drug identifying data for fulfillment from said mail order pharmacy program; and
(m) transmitting said order from said server to a fulfillment system for said mail order pharmacy program.

16. The computerized method of claim 15 wherein generating at said server for display at said user computer a second screen comprising at least one mail order pharmacy program option associated with said drug identifying data comprises generating a mail order pharmacy program option for a generic equivalent of said drug.

17. The computerized method of claim 15 wherein generating at said server for display at said user computer a second screen comprising at least one mail order pharmacy program option associated with said drug identifying data comprises generating a mail order pharmacy program option for a generic alternative of said drug.

18. The computerized method of claim 15 wherein receiving at said server from said user computer a request to add a prescription to a prescription list for said member comprises a request to add a prescription to a prescription list comprising a plurality of prescriptions identified in said member's pharmacy claim data.

19. The computerized method of claim 18 wherein said prescription list comprises prompts for entering prescribing physician data.

20. (canceled)
